(19) United States
(12) Patent Application Publication
(10) Pub. No.: US 2024/0378108 A1
(43) Pub. Date: Nov. 14, 2024

(54) BUILDING A MODEL REPRESENTING COMPONENTS IN A SYSTEM BASED ON RELIABILITY PATTERNS AND OPERATIONAL STATES OF THE COMPONENTS

(71) Applicant: INTERNATIONAL BUSINESS MACHINES CORPORATION, Armonk, NY (US)

(72) Inventor: Ingo Averdunk, Markt Schwaben (DE)

(21) Appl. No.: 18/316,133

(22) Filed: May 11, 2023

(51) Int. Cl. G06F 9/54

(52) U.S. Cl. CPC G06F 11/0793; G06F 11/3055; G06F 11/3447

(57) ABSTRACT

Provided are a computer program product, system, and method for building a model representing components in a system based on reliability patterns and reliability states of the components. Link information indicates a caller component, at least one callee component, a reliability pattern, in which the caller component and the at least one callee component participate, indicating a dependence between the caller component and the at least one callee component, and at least one link state indicating an operational state between the at least one callee component and the caller component. A determination is made of a reliability state for the caller component based on the at least one link state of the at least one callee component and the reliability pattern. The reliability state is indicated for the caller component.

### BACKGROUND OF THE INVENTION

### 1. Field of the Invention

The present invention relates to a computer program product, system, and method for building a model representing components in a system based on reliability patterns and reliability states of the components.

### 2. Description of the Related Art

When a component in a system, such as a service or application, calls another component in the system, to guarantee reliability of the call, a set of architecture and reliability design patterns are typically deployed to handle possible failures of the called components. Examples of reliability design patterns include redundancy, queues, circuit-breaker, automatic retries, bulkhead patterns, etc. The benefit of these reliability design patterns is that the failure of an individual component (or sub-service, API) will not directly affect the complete reliability of the overall application or service that depends on the called components. In this way, reliability design patterns provide reliability to multiple services and components in a system.

There is a need in the art for improved techniques to model systems including reliability design patterns to capture the effect of the reliability design patterns on components in the system and to allow for improved diagnosis and analysis of the system states.

### SUMMARY

Provided are a computer program product, system, and method for building a model representing components in a system based on reliability patterns and reliability states of the components. Link information indicates a caller component, at least one callee component, a reliability pattern, in which the caller component and the at least one callee component participate, indicating a dependence between the caller component and the at least one callee component, and at least one link state indicating an operational state between the at least one callee component and the caller component. A determination is made of a reliability state for the caller component based on the at least one link state of the at least one callee component and the reliability pattern. The reliability state is indicated for the caller component.

### BRIEF DESCRIPTION OF THE DRAWINGS

FIG. 1 illustrates an embodiment of a system and a reliability monitor to model reliability design patterns in a computing system.

FIG. 2 illustrates an embodiment of node information on a component of the system.

FIG. 3 illustrates an embodiment of link information for a caller-callee pair of components in the system.

FIG. 4 provides a table of information on different reliability patterns, including operational states and tags.

FIG. 5 illustrates an embodiment of operations to add information on a component and its reliability design to a model of the system and deployed reliability patterns.

FIGS. 6A, 6B, 6C, 6D, 6E, 6F, 6G, 6H, 6I illustrate examples of reliability design patterns of components called by a service in a system.

FIG. 7 illustrates an embodiment of operations to update operational states in information maintained for components involved in reliability design patterns.

FIGS. 8A and 8B illustrate examples of updates to the operational states in information on components in reliability design patterns.

FIG. 9 illustrates an embodiment of a computer architecture used with described embodiments.

### DETAILED DESCRIPTION

Described embodiments provide improved computer technology to model a system having interrelated services and components participating in reliability patterns to protect against failure and to provide real-time and current awareness of operational states of the interrelated components and reliability states of the reliability patterns in which the services and components participate. Accurate reliability state information is propagated from downstream components, whose participation in downstream reliability patterns affects the reliability state of upstream components and their reliability patterns. A reliability state of an upstream reliability pattern is an aggregate of the reliability states of downstream components and services and downstream reliability patterns in which the downstream components participate.

Operational activities, such as maintenance, require accurate operational state information on the system components and reliability patterns in which the components participate to plan and prioritize workflow. To accomplish this required accuracy, described embodiments propagate changes to a reliability state of reliability patterns of components upwards to other reliability patterns that depend on downstream reliability patterns to incorporate those changed reliability states into the reliability states and operational states of components that directly or indirectly rely on operations of the downstream reliability patterns. Described embodiments model and track the reliability states of reliability patterns of components in the system to propagate and aggregate the effects on the overall system. The link information is aggregated and propagated across the various tiers, enabling proper diagnosis and corrective actions for the system.

With described embodiments, the model is traversed, and an overall reliability state or risk is determined based on the state information of the individual links and components. In this way, the model has information on the reliability patterns and their reliability states. With this model, an artificial intelligence operations engine may calculate the overall risk based on the reliability and operational states of the individual components and reliability patterns.

A reliability state of a component would be operational if all interrelated subcomponents in the reliability pattern are working; non-operational if one or more downstream reliability patterns failed, exhausted, or a component with no reliability pattern failed; or marginal if one or more reliability patterns of downstream components are in effect.

In further embodiments, an analysis of the model may evaluate a marginal state to provide more insight on the aggregated risk, specific to the system in scope. For instance, the aggregated risk may consider a threshold on the amount of reliability patterns in effect at a point in time (e.g., no more than a specified number of patterns should be in effect); a trend of the amount of reliability patterns in effect; and a prediction on the typical duration of pattern in effect, mapped with the trend of new patterns becoming effective (e.g., a time it takes to replace a disk in a Redundant Array of Independent Disks (“RAID”) system); and a weighting of risk by pattern (e.g., a retry may be less risky compared to a missing redundancy).

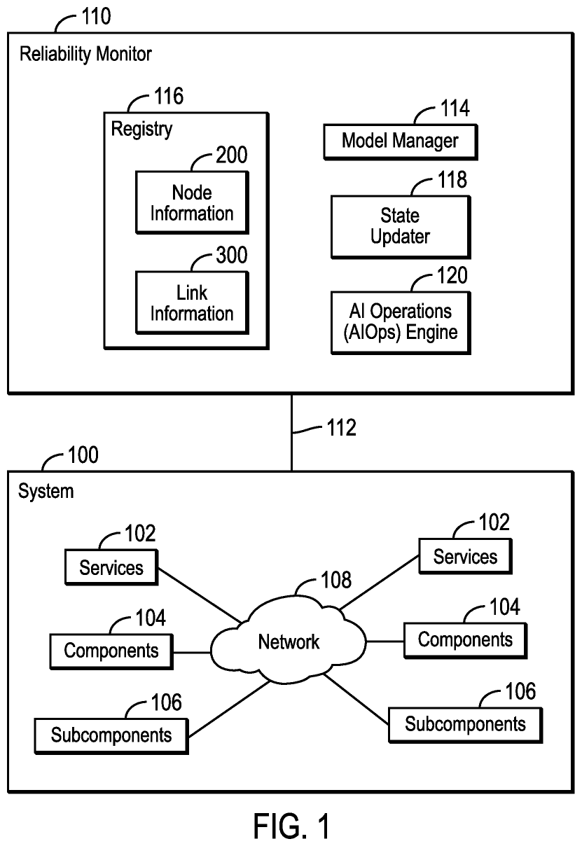

FIG. 1 illustrates an embodiment of a computing environment having a system 100 comprised of numerous interrelated components, including services 102, components 104 that may be called by the services 102 or other components 104, and subcomponents 106 called by components. The services 102 and components 104, 106 may comprise application programs and/or hardware, such as computing resources, servers, storage resources, network resources, etc., that communicate over one or more networks 108. Certain of the components 102, 104, 106 may be located on a same computing platform, such as server, and call each other through memory calls. A service 102, component 104 and subcomponent 106 may call another service, component and subcomponent through an Application Programming Interface (API) or other type of call, including local calls within the same system and remote calls, such as remote procedure calls (RPCc) over the network 108.

A reliability monitor 110 is coupled to the system 100 components 102, 104, 106 through an in-band or out-of-band network 112 to gather information on the components, reliability patterns in which the components participate, reliability states of the reliability patterns, and operational states of the components to build a model of the system 100. In further embodiments, the reliability monitor 110 may be implemented within a computing platform having the components 102, 104, 106 and may communicate through memory.

The reliability monitor 110 may gather information on the operational states of components and their reliability patterns from logged information, received from messages, and from querying the components. The reliability monitor 110 includes a model manager 114 that processes information on the components 102, 104, 106 added to the system 100 and adds, to a registry 116, component node information 200 on the reliability pattern and operational state of components and link information 300 on a reliability pattern having a calling relationship between a caller component and a callee component; a state updater 118 to process the component node information 200 and link information 300 to determine a current operational state of the components 102, 104, 106 and update the state information if it has changed (alternatively, components 102, 104, 106 may alert the state updater 118 of changes); and an Artificial Intelligence for IT Operations (AIOps) engine 120 to process the component node information 200 and link information 300 and determine, diagnose, and correct problems and improve settings.

The model manager 114 and state updater 118 may be part of the AIOps process to gather reliability relationships and operational states of the components in the system 100. The AIOps engine 120 may the process and analyze the model of the system 100 components, as represented by the component node information 200 and link information 300, using artificial intelligence and machine learning algorithms to detect patterns, anomalies, and other useful insights. The AIOps engine 120 may identify the root causes of issues and problems and suggest potential remediation steps. The AIOps engine 120 may also automate the incident response process by triggering automated remediation workflows, notifying relevant stakeholders, and providing real-time updates on the incident.

The model manager 114 builds a model that provides a representation of a given service (or application) and its underlying components, sub-services APIs, reliability patterns, etc. The model contains nodes which are representations of the interrelated components 102, 104, 106, such as sub-services, sub-applications, APIs, etc. The link information 300 represents how the nodes/components are interconnected in reliability patterns where a caller node is dependent on operations of at least one callee component according to a reliability pattern. Reliability describes the ability of a system or component to function under stated conditions for a specified period of time, and is characterized through aspects such as availability, latency, correctness, durability, freshness, etc. The link information 300 describes the dependency in terms of reliability patterns types, such as Direct, Redundancy, Degradation, Retry, Waterfall, Sharding, Queuing, Caching, Compensation, Circuit-breaker, Bulkhead, Rate Limiter, Throttling, Time Limiter, Fail Static, Load Shedding, Waiting Room, etc.

The model manager 114, state updater 118, AIOps engine 120, service 102, components 104, and subcomponents 106 may comprise program code loaded into a memory and executed by one or more of the processors. Alternatively, some or all of the functions may be implemented as microcode or firmware in hardware devices in the system components 102, 104, 106, and reliability monitor 110, such as in Application Specific Integrated Circuits (ASICs).

The components 102, 104, 106 may further include hardware elements that may be utilized by a calling service or component.

The networks 108, 112 may be implemented in one or more networks, comprising as a Storage Area Network (SAN), a Local Area Network (LAN), a Wide Area Network (WAN), a Fibre Channel network, the Internet, and Intranet, a Peripheral Component Interconnect (PCI) bus interface, etc.

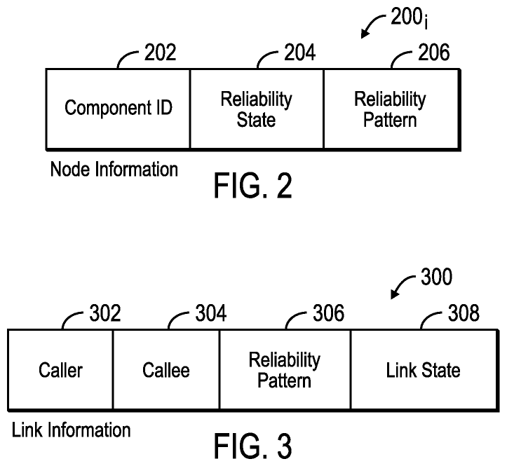

FIG. 2 illustrates an embodiment of component node information 200ᵢ that is an instance of the component node information 200 for a component having a component identifier (ID) 202 identifying the service or component in the system 100; a reliability state 204 of the component, such as operational, non-operational, and marginal; and a reliability pattern 206 indicating a reliability relationship to another component called by the component 202, as recorded in link information 300ᵢ instances.

FIG. 3 illustrates an embodiment of link information 300ᵢ that is an instance of the link information 300 providing information on a reliability pattern including a caller component calling a callee component, and includes: a caller component 302 initiating the call, usually in response to a request from a service 102; a callee 304 comprising the component receiving the call; a reliability pattern 306 indicating a reliability pattern or operational dependency between the caller component 302 and the callee 304; and a link state 308 of the link represented by the link information 300ᵢ, which is usually dependent on the reliability state or operational state of the callee in the link. If a reliability pattern is defined with one caller component and multiple callee components, like for redundancy and bulkhead reliability patterns, then there may be one instance of link information 300ᵢ for each caller-callee pair in the reliability pattern to define that reliability relationship between each caller-callee.

Reliability, as implemented through reliability patterns, is the ability of a system or component to function under stated conditions for a specified period. Reliability assures a component or the system 100 performs its intended function for the required duration within a given environment, including the ability to test and support the system through its total lifecycle. The reliability pattern 206 may comprise, but is not limited to, one of the following reliability patterns:
Direct: indicating the component having this reliability pattern does not call another component. The operational statement of a component having direct reliability is determined by the operations of the component itself if the component does not call another sub-component. If the component calls another component, then the caller component state is the state of the called component.
Redundancy: provide redundant instances of the same component to avoid single points of failure by allowing a failover to a functioning component. An example includes a Redundant Array of Independent Disks (RAID) storage, such that if one disk fails, the storage can be rebuilt in the remaining disks.
Degradation: For some services, not every transaction is expected to succeed and users may have a tolerance for a limited number of failed requests. Degradation allows certain requests to fail.
Retry: The calling component automatically retries a transient failure. If a response is not returned in the expected time, the caller resends the same request.
Waterfall: The caller may initiate multiple instances of the transaction to send to the callee and then select the best response to return to the service invoking the callee. The selected response to return may comprise a fastest response or one of best quality. Results not accepted may be dropped or used to complete a subsequent transaction.
Sharding: A workload is partitioned into distinct independent parts to improve availability and performance. The partitions may be processed in parallel and completed on different nodes and then combined to form the final result
Queuing: caller may queue requests and the queued requests are sent asynchronously to the caller to improve the stability of the system. The queue removes peaks of request rates at the service, serializes the requests, and ensures that the request rate that is directed to the service is capped at a certain rate.
Caching: caller or callee stores data to return to a subsequent same request.
Compensation: Record all the steps of workflow and start to undo the operations if a failure occurs. When a step in a distributed workflow fails, the previous steps must be undone. A journal tracks all the steps that were performed. As a means of compensation, the journal reverts those operations in a failure.
Circuit-breaker: Detect failures and encapsulate the logic of preventing a failure from constantly recurring during maintenance, temporary external system failure, or unexpected system difficulties. When circuit-breaker is in the closed state, communication occurs between the circuit-breaker component (or subcomponent) and the supplier component (or subcomponent) of a microservice. If the suppler subcomponent is not available, then circuit state changes to open state where failure is immediately reported back to the service that invoked the caller after a timeout period during which the supplier subcomponent does not reply to the circuit-breaker component. After a period of time, as determined by policy, the circuit state changes to half-open where the caller retries the request to see if the callee is now operational and, if so, changes to the closed state.
Bulkhead: components performing different operations are isolated so if one fails, the other components are not effected and the caller may call the components that remain operational.
Rate Limiter: a defensive technique that limits the number of requests that can reach the callee in order to protect the callee component from unintended or malicious overuse.
Time Limiter: limits the number of requests to the callee allowed at the same time, or limits the number of requests for a given time period.
Fail Static: Limit the number of resources that a service uses so that the service can continue to function. For instance, during a time of severe load, larger, less latency sensitive network traffic may be dropped.
Load Shedding: Deliberately quiesces requests from consumers to protect the grid from collapse. If the demand on the system is greater than the available supply, load shedding prevents an imbalance and subsequent blackout. Load shedding is also implemented if time is insufficient to request load curtailment
Waiting Room: Provide a waiting room experience when the back-end application becomes overloaded.

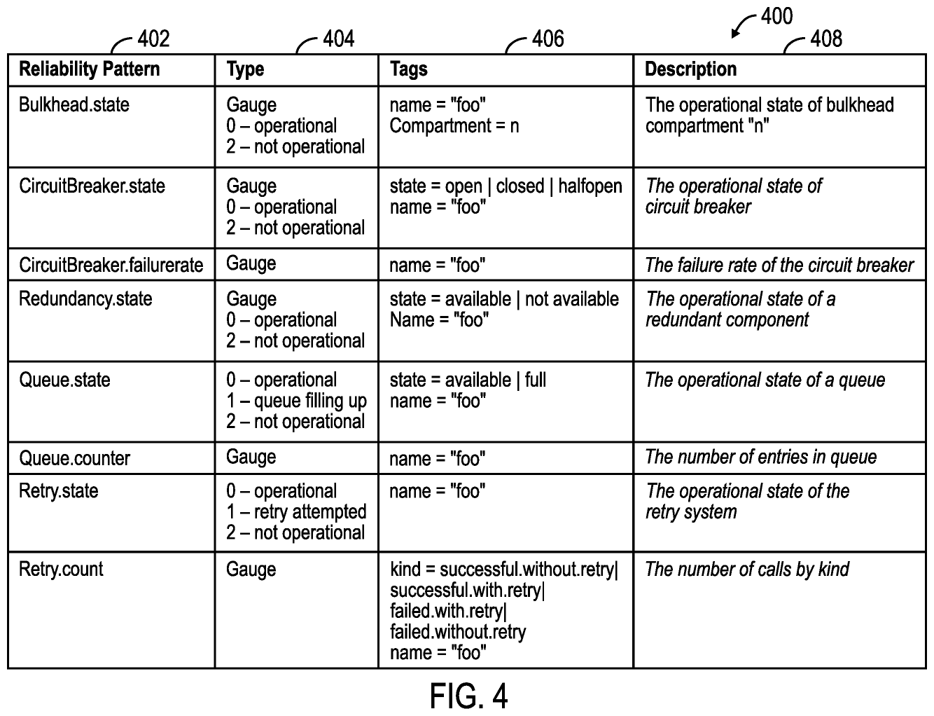

FIG. 4 comprises a table 400 providing an embodiment of different reliability patterns 402 having different possible reliability states 404 for the reliability pattern 402 in the corresponding row; a tag 406 providing further information on the reliability pattern, such as a compartment “n” for bulkhead reliability pattern or state of circuit-breaker for a circuit-breaker reliability pattern; and a description of the operational state with respect to the tagged item.

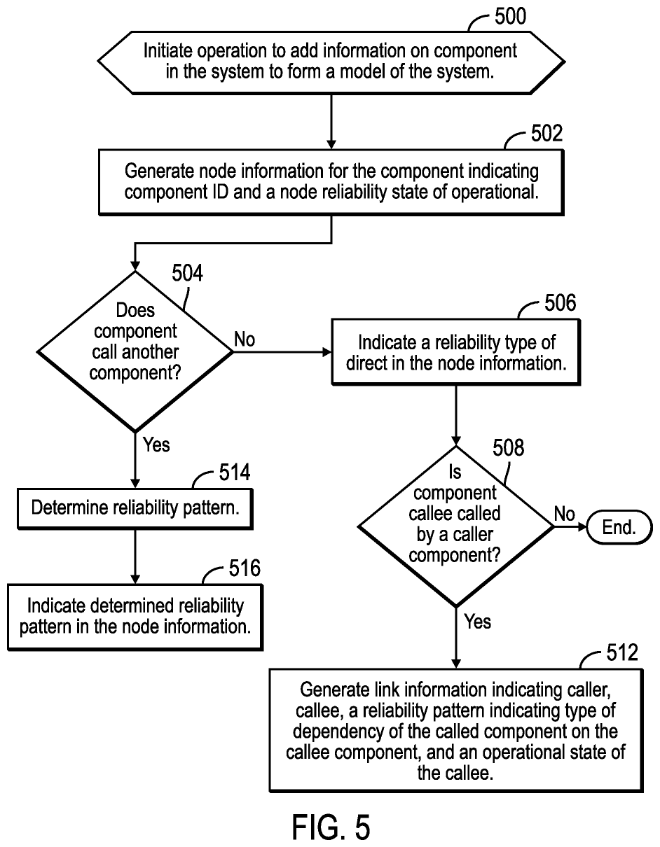

FIG. 5 illustrates an embodiment of operations performed by the model manager 114 to add component node information 200; and link information 300; on a component 102, 104, 106 and reliability patterns in the system 100 to the registry 116 to define the model of the system 100. Upon initiating (at block 500) an operation to add information on a component, such as component 104ᵢ, in the system to form a model of the system 100, the model manager 114 generates (at block 502) component node information 200; for the component 102; indicating component ID 202 and a node reliability state 204 indicating operational. In one embodiment when adding a plurality of nodes in an interconnected calling relationship, component node information 200 and link information 300 on the highest level nodes in a chain of caller-callees is added first. If (at block 504) the component 104; being added does not call a callee component, then the model manager 114 indicates (at block 506) a reliability pattern 206 of direct in the component node information 200ᵢ, which indicates the component reliability is not based on another node, such as a callee node. If (at block 508) the component being added is a callee called by a caller component, then link information 300ᵢ is generated (at block 512) indicating the caller component 302, the component being added as the callee 304, the reliability pattern 306 indicating a reliability pattern between the caller and callee, and the link state 308 as operational.

If (at block 504) the component 104ᵢ does call a callee component, then the reliability pattern for the call is determined (at block 514). The determination may be made from metadata on the component 104ᵢ. The determined reliability pattern 206 is indicated in the component node information 200ᵢ for the added node. In one embodiment, the link information 300ᵢ is added when the component node information 200ᵢ for the callee component is added to the registry 116.

With the embodiment of FIG. 5, component node information 200; and link information 300ᵢ are added to the registry 116 as components are added to the system 100 to form a model representation of the system 100, including information on dependency of components on one another in reliability patterns. This reliability and operational information may then be used to determine the resiliency and fragility of the system 100.

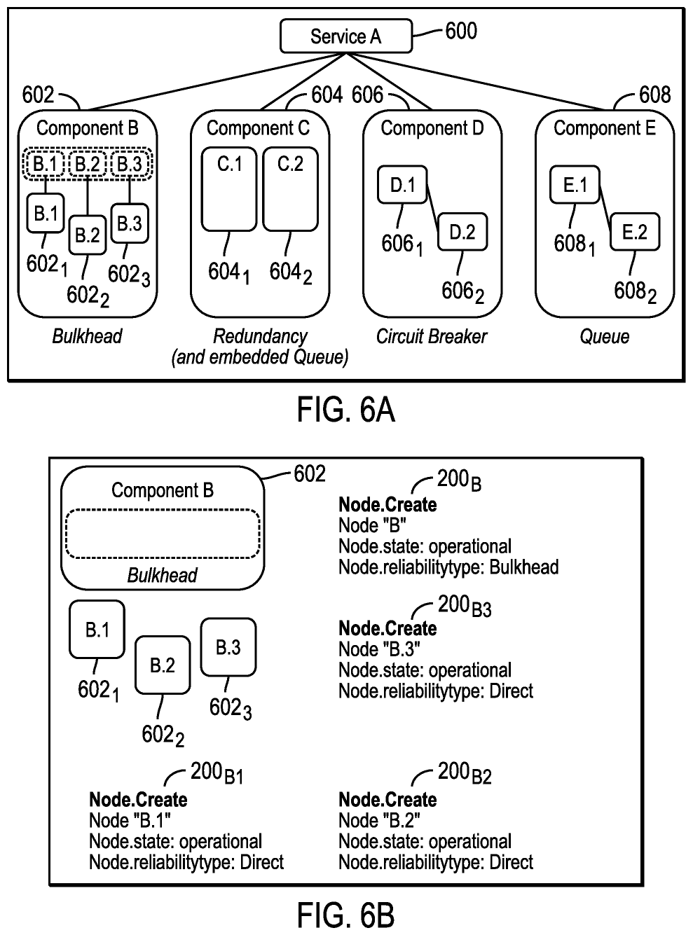

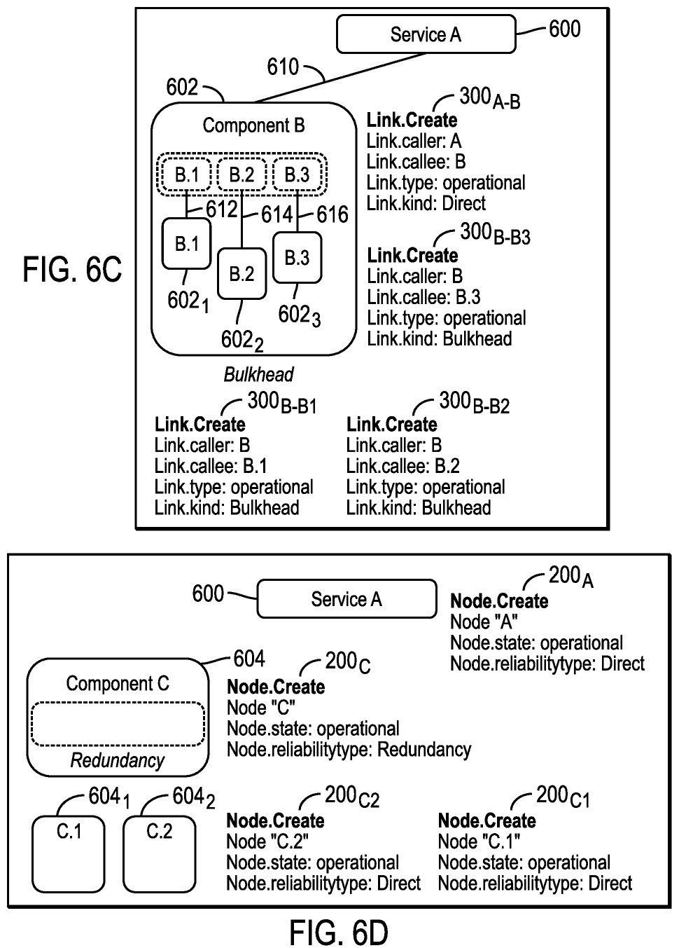

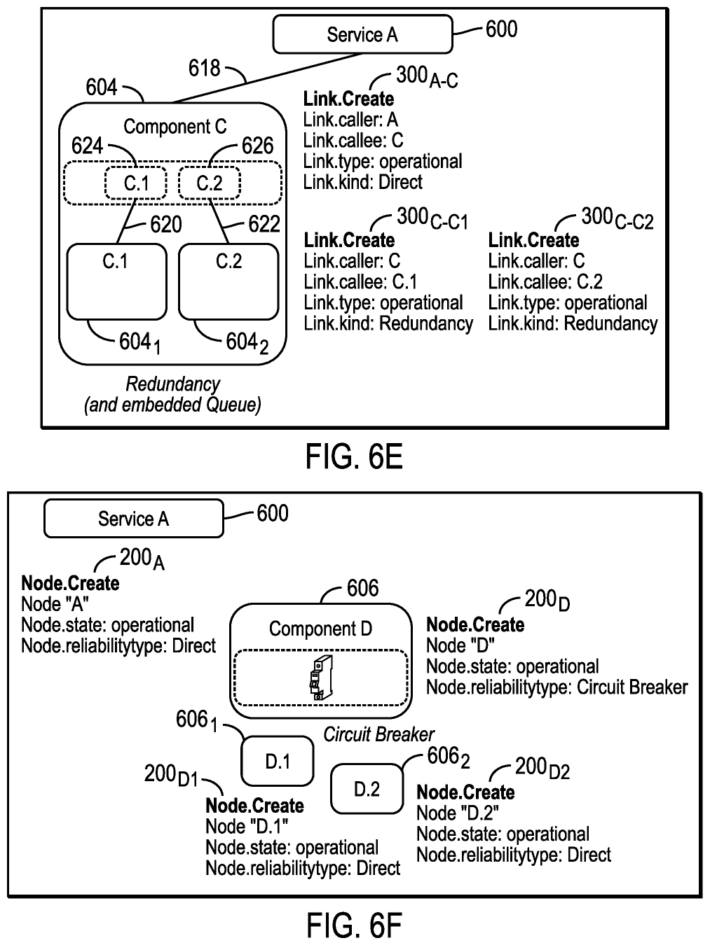

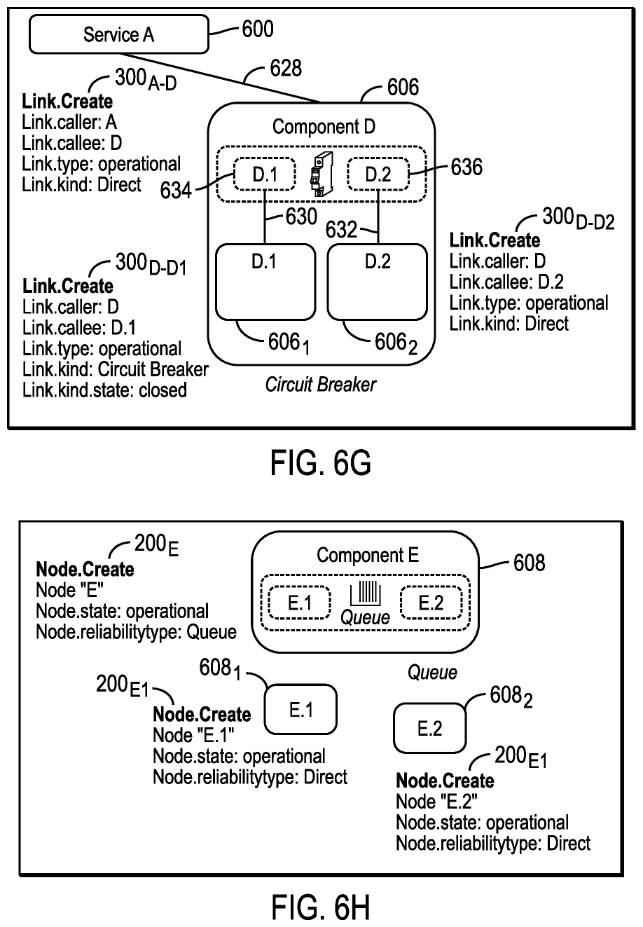

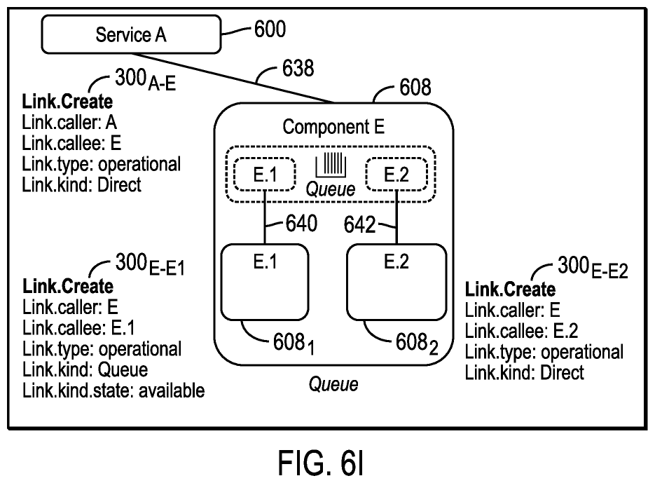

FIG. 6A provides an example of caller-callee relationships, where service A 600 may call any one of the components 602, 604, 606, 608. Each of the components 602, 604, 606, 608, when invoked by the service 600, may call subcomponents 602₁, 602₂, 602₃; 604₁, 604₂; 606₁, 606₂, and 608₁, 608₂, shown as included in the components 602, 604, 606, 608 of reliability patterns of bulkhead, redundancy, circuit-breaker, and queue, respectively. In actual implementations, there may be multiple independent services 600 in the system 100 that may have links to multiple levels, including more than the two levels of links shown in FIG. 6A.

FIG. 6A further illustrates caller-callee chains, such as service 600 calling component 602 which in turn calls the subcomponents 602₁, 602₂, 602₃ providing three different caller-callee chains, where errors or degradations in the final subcomponents in the chain, e.g., 602₁, 602₂, 602₃, propagate upwards towards other components in the caller-callee chain.

FIGS. 6B, 6C, 6D, 6E, 6F, 6G, 6H, 6I illustrate how node information is added as the components of FIG. 6A are added to the system 100 according to the operations of FIG. 5. FIG. 6B shows the node information 200_{B}, 200_{B1}, 200_{B2}, 200_{B3} added for component 602 and the bulkhead subcomponents 602₁, 602₂, 602₃, providing isolated different functions, called by component 602.

FIG. 6C shows how link information 300_{A-B} is created, as shown as links representing dependencies of components, where link 610 represents the call from service 600 to component 602, and link information 300_{B-B1}, 300_{B-B2}, 300_{B-B3} is created for links 612, 614, 616, respectively, representing the calls from component 602 to bulkhead subcomponents 602₁, 602₂, 602₃. The reliability pattern is defined by the link information 300_{B-B1}, 300_{B-B2}, 300_{B-B3} defining how component 602 calls bulkhead subcomponents 602₁, 602₂, 602₃.

FIG. 6D shows the node information 200_{A}, 200_{C}, 200_{C1}, 200_{C2} added for service 600, component 604 and the redundant subcomponents 604₁, 604₂ called by component 604 as part of a redundancy reliability pattern.

FIG. 6E shows link information 300_{A-C}, 300_{C-C1}, 300_{C-C2} created for the links 618, 620, 622 representing the calls from service 600 to component 604 and representing the calls from component 604 to redundant subcomponents 604₁, 604₂. The reliability pattern is defined by the link information 300_{C-C1}, 300_{C-C2} defining how component 604 calls redundancy subcomponents 604₁, 604₂. FIG. 6E further shows an additional layer of reliability in the form of embedded queues 624, 626 to provide further resiliency for the subcomponents.

FIG. 6F shows the node information 200_{A}, 200_{D}, 200_{D1}, 200_{D2} added for service 600, component 606 and the circuit-breaker subcomponents 606₁, 606₂ called by component 606 as part of circuit-breaker reliability. Subcomponent 606₁ comprises the circuit-breaker and subcomponent 606₂ comprises the circuit-breaker supplier of the service. The circuit-breaker subcomponent 606₂ may be opaque and not represented in the model. However, the model as shown in FIG. 6F represents the supplier subcomponent 606₂ to allow tracking of target information, such as availability and latency of the supplier, to incorporate into the model.

FIG. 6G shows link information 300_{A-D}, 300_{D-D1}, 300_{D-D2} created for the links 628, 630, 632 representing the calls from the service 600 to component 606 and representing the calls from component 606 to circuit subcomponents 606₁, 606₂. FIG. 6G further shows an additional layer of reliability in the form of embedded queues 634, 636 to provide further resiliency for the subcomponents. The reliability pattern is defined by the link information 300_{D-D1}, 300_{D-D2} defining how component 606 calls circuit breaker subcomponents 606₁, 606₂.

FIG. 6H shows the node information 200_{E}, 200_{E1}, 200_{E2} added for queue component 608 and the queue subcomponents 608₁, 608₂ called by component 608 as part of a queue reliability design. The queue subcomponent 608₁ comprises the queue-to-queue requests and subcomponent 608₂ comprises a queue consumer of the queue that processes queued requests. The queue consumer subcomponent 608₂ may be opaque and not represented in the model. However, the model as shown in FIG. 6H, represents the queue consumer 608₂ to track consumer information (such as threshold or performance) and incorporate into the model.

FIG. 6I shows link information 300_{A-E}, 300_{E-E1}, 300_{E-E2} created for the links 638, 640, 642 representing the calls from service 600 to component 608 and representing the calls from component 608 to the queue 608₁ and the consumer 608₂ that processes requests in the queue 608₁. The reliability pattern is defined by the link information 300_{E-E1}, 300_{E-E2} defining how component 608 calls queue subcomponents 608₁, 608₂.

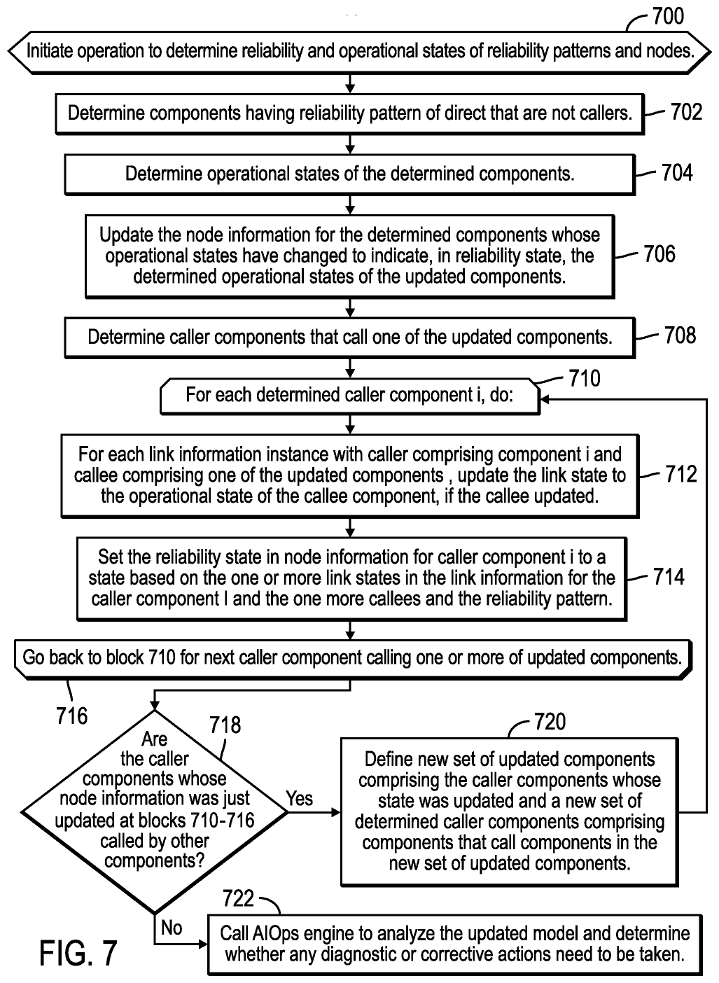

FIG. 7 illustrates an embodiment of operations performed by the state updater 118 to update the operational states at the nodes. Upon initiating (at block 700) operations to determine operational states of the components and links, the state updater 118 determines (at block 702) components whose node information 200; has a reliability pattern 206 of direct and that are not callers, which means they are a leaf or ending node on a chain of caller-callee nodes. The state updater 118 determines (at block 704) current operational states of the determined components, which may be determined from messages, log information or by querying the components. The reliability state 204 of a component having a direct reliability pattern that does not call another component would be the operational state of the node. The component node information 200; for the determined components whose reliability states 204 have changed are updated (at block 706) to indicate, in reliability state 204, the determined operational states of the component. A determination is made (at block 708) of caller components that call one of the updated components.

For each of the determined caller components i, the state updater 118 performs a loop of operations at blocks 710 through 716. For each link information instance 300; with a caller component 302 comprising component i and callee 304, comprising one of the updated components, the state updater 118 updates (at block 712) the link state 308 based on the reliability pattern and the determined operational states of the callee component(s), including any updated callees. The reliability state 204 of the component node information 200; for the caller component i is set (at block 714) based on the link states 308 in the link information 300ᵢ, for the caller component i and at least one callee component, and the reliability pattern 206. After updating the component node information 200; and link information 300; for all determined caller components i calling one of the updated subcomponents, the state updater 118 determines (at block 718) whether there are caller components whose component node information 200; was updated according to blocks 710 through 716 that are callees called by up-stream components. If the caller components are also callees, then a new set of updated components is defined (at block 720) comprising the caller components whose state was updated and a new set of determined caller components comprising components that call components in the new set of updated components comprising the previous callers. Control then proceeds back to block 710 et. seq. to update the component node information 200ᵢ and link information 300ᵢ for the new set of caller components that call the recently updated components. After all caller components in the chains of caller-callee components have been updated, the AIOps engine 120 may be invoked (at block 722) to analyze the updated model, as defined by the updated component node information 200 and link information 300, and determine diagnostic and corrective a actions to perform.

With the embodiment of operations of FIG. 7, the state updater 118 may periodically scan the nodes of the model to update operational state information for the node information. Alternatively, the state updater 118 may initiate operations in response to a message from one of the components that its reliability state has changed or in response to processing log information indicating a changed state. In this way, the reliability state of all components that depend on subcomponents in a chain of caller-callees are updated and the effect on caller components in the chain is also determined to update the reliability states of caller components that call callees whose reliability state has changed. The result is that the model accurately reflects current aggregated reliability states of nodes based on the reliability patterns in which caller components call callee components and reliability states of downstream components and their reliability patterns.

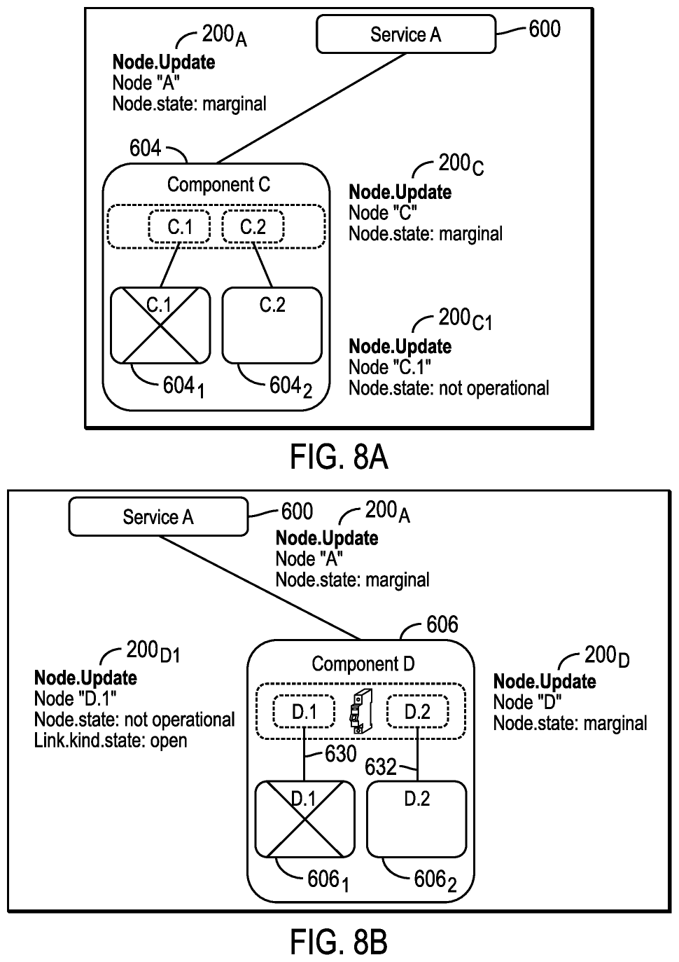

FIG. 8A illustrates an example of how a change in the reliability state of a redundant subcomponent 604₁, such as a disk drive when the component 604 comprises a RAID storage drive, to not operational. This reliability state change is propagated upwards, according to the operations of FIG. 7, to change the reliability state in the node information 200_{C}, and 200_{A} for component 604 and service 600 to reflect that the reliability states of these up-level components in the caller-callee chain have their reliability state degraded to marginal, due to the failure of one of the redundant subcomponents 604C₁, 604C₂. The determination of how far up the caller-callee chain the effect of the non-operational state propagates depends on the reliability pattern and a defined propagation level for the reliability pattern.

FIG. 8B illustrates an example of how a change in the operational state of the circuit-breaker subcomponent 604₁ to not operational and the OPEN circuit state when the supplier 604₂ is not responding, as shown in node information 200_{D1}, is propagated upwards, according to the operations of FIG. 7, to change the reliability state 204 in the node information 200_{D}, and 200_{A} for component 606 and service component 600 to marginal. This change reflects that the operational states of these up-level components in the caller-callee chain have their operational state degraded to marginal, due to the failure of the circuit-breaker subcomponent 606₁.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code, in block 945, involved in performing the inventive methods, such as the model manager 114 and state updater 118 to generate and update node and link information to form a model of components in the system and their calling relationships, reliability, and operational states to allow for diagnosis and corrective action by the AIOps engine 120. In addition to block 945, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and computing code 945, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

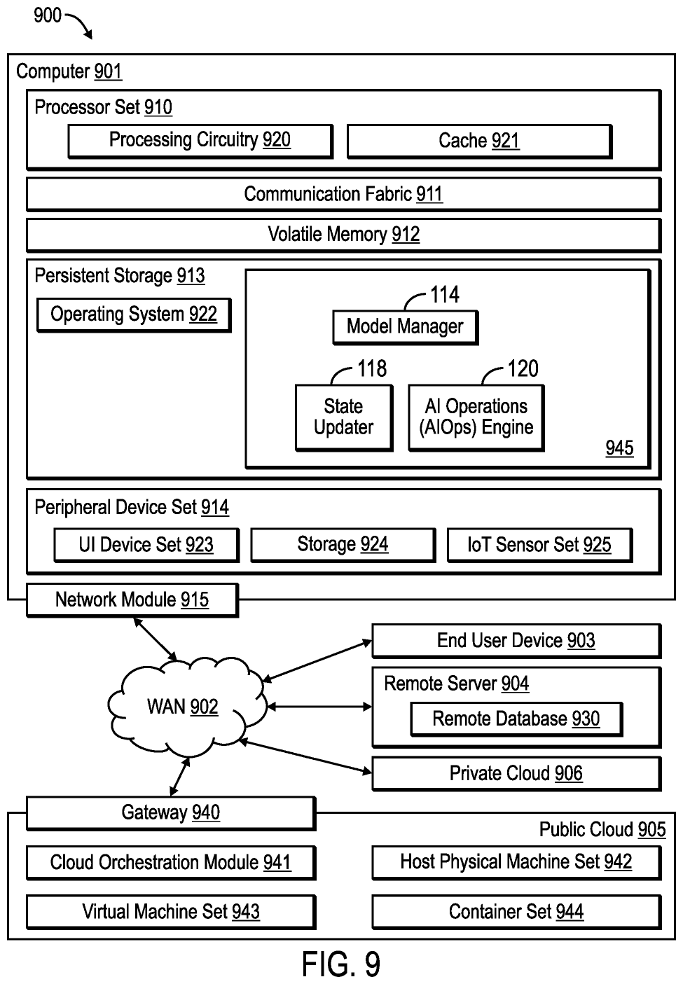

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 945 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in block 945 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 115 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on. The EUD 903 may further comprise the system 100 and components 102, 104, and 16.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The letter designators, such as i and j are used herein to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for determining a state of interrelated components in a system, the computer program product comprising a computer readable storage medium having computer readable program code that when executed by a processor performs operations, the operations comprising:
generating link information indicating a caller component, at least one callee component, a reliability pattern, in which the caller component and the at least one callee component participate, indicating a dependence between the caller component and the at least one callee component, and at least one link state indicating an operational state between the at least one callee component and the caller component;
determining a reliability state for the caller component based on the at least one link state of the at least one callee component and the reliability pattern; and
indicating the reliability state for the caller component.

2. The computer program product of claim 1, wherein an aggregate reliability state of the system having multiple reliability patterns of components comprises:
operational if all the components in all the reliability patterns are operating;
non-operational if one or more reliability patterns failed or a component not in a reliability relationship with other components failed; and
marginal if one or more reliability patterns are in effect.

3. The computer program product of claim 1, wherein the reliability state comprises at least one of operational, marginal, and not operational, wherein the reliability state for the reliability pattern having multiple callee components is operational in response to the multiple callee components having the operational state.

4. The computer program product of claim 1, wherein there are a plurality of reliability patterns for components including an upstream reliability pattern whose components have dependency on components of a downstream reliability pattern, wherein a reliability state of the upstream reliability pattern is dependent on a reliability state of the downstream reliability pattern.

5. The computer program product of claim 1, wherein the reliability pattern is a member of a set of reliability patterns consisting of: redundancy, degradation, retry, waterfall, sharding, queuing, caching, compensation, circuit-breaker, throttling, bulkhead rate limiter, time limiter, fail static, load shedding, and waiting room.

6. The computer program product of claim 1, wherein the operations further comprise:
generating node information indicating reliability states of the caller component and the callee component, wherein the reliability state of the caller component is based on link states between the caller component and the at least one callee component;
indicating the reliability state in the node information for the caller component as operational in response to the link states for the callee components indicating operational;
indicating the reliability state in the node information for the caller component as marginal in response to the link states for the callee components indicating both operational and non-operational; and
indicating the reliability state in the node information for the caller component as non-operational in response to the link states for the callee components indicating non-operational.

7. The computer program product of claim 1, wherein the at least one callee component comprises subcomponents called by the caller component, wherein the link information is for the reliability pattern comprises redundancy where the caller component calls the subcomponents, wherein the subcomponents comprise a same type of component to provide redundancy reliability to the caller component, wherein the operations further comprise:
indicating the reliability state, in the link information for the caller component as a caller, as operational in response to reliability states of the subcomponents indicating operational;
indicating the reliability state, in the link information for the caller component, as marginal in response to the reliability states of the subcomponents indicating operational and non-operational; and
indicating the reliability state, in the link information for the caller component, as non-operational in response to the reliability states for the subcomponents indicating non-operational.

8. The computer program product of claim 1, wherein the at least one callee component comprises a circuit-breaker subcomponent that forwards responses to a supplier subcomponent, wherein link states for the circuit-breaker subcomponent and the supplier subcomponent indicates one of: a closed state when the supplier subcomponent is responding to service requests from the circuit-breaker subcomponent, an open state to immediately return an error to the callee component after a timeout period during which the supplier subcomponent does not reply to the circuit-breaker subcomponent, and a half-open state when the circuit-breaker subcomponent allows a limited number of requests to pass to the supplier subcomponent, wherein the operations further comprise:
indicating the reliability state of the caller component as not operational in response to the link states indicating the open state or the half-open state;
indicating the reliability state of caller component as operational in response to the link states indicating closed; and
indicating the reliability state of the caller component as marginal in response to the link states indicating non-operational.

9. The computer program product of claim 1, wherein the at least one callee component comprises subcomponents called by the caller component, wherein the link information for the caller component and the subcomponents indicates a reliability pattern of bulkhead, wherein the subcomponents comprise different types of subcomponents whose operations and states are isolated and independent from one another, wherein the operations further comprise:
indicating a reliability state, in the link information for the caller component as a caller, as operational in response to reliability states of the subcomponents indicating operational;
indicating the reliability state, in the link information for the caller component, as marginal in response to the reliability states of the subcomponents indicating operational and non-operational; and
indicating the reliability state, in the link information for the caller component, as non-operational in response to the reliability states for the subcomponents indicating non-operational.

10. The computer program product of claim 1, wherein the operations further comprise:
using an artificial intelligence program to process the link information to identify patterns related to performance in the system and availability of the components; and
processing the identified patterns and the availability of the components to diagnose causes of problems in the identified patterns and the availability of the components to determine actions to resolve the causes of the problems.

11. A reliability monitor system for determining a state of interrelated components in a system, comprising:
a processor; and
a computer readable storage medium having computer readable program code that when executed by the processor performs operations, the operations comprising:
generating link information indicating a caller component, at least one callee component, a reliability pattern, in which the caller component and the at least one callee component participate, indicating a dependence between the caller component and the at least one callee component, and at least one link state indicating an operational state between the at least one callee component and the caller component;
determining a reliability state for the caller component based on the at least one link state of the at least one callee component and the reliability pattern; and
indicating the reliability state for the caller component.

12. The reliability monitor system of claim 11, wherein an aggregate reliability state of the system having multiple reliability patterns of components comprises:
operational if all the components in all the reliability patterns are operating;
non-operational if one or more reliability patterns failed or a component not in a reliability relationship with other components failed; and
marginal if one or more reliability patterns are in effect.

13. The reliability monitor system of claim 11, wherein there are a plurality of reliability patterns for components including an upstream reliability pattern whose components have dependency on components of a downstream reliability pattern, wherein a reliability state of the upstream reliability pattern is dependent on a reliability state of the downstream reliability pattern.

14. The reliability monitor system of claim 11, wherein the operations further comprise:
generating node information indicating reliability states of the caller and the callee components, wherein the reliability state of the caller component is based on link states between the caller component and the at least one callee component;
indicating the reliability state in the node information for the caller component as operational in response to the link states for the callee components indicating operational;
indicating the reliability state in the node information for the caller component as marginal in response to the link states for the callee components indicating both operational and non-operational; and
indicating the reliability state in the node information for the caller component as non-operational in response to the link states for the callee components indicating non-operational.

15. The reliability monitor system of claim 11, wherein the at least one callee component comprises subcomponents called by the caller component, wherein the link information is for the reliability pattern comprises redundancy where the caller component calls the subcomponents, wherein the subcomponents comprise a same type of component to provide redundancy reliability to the caller component, wherein the operations further comprise:
indicating the reliability state, in the link information for the caller component as caller, as operational in response to reliability states of the subcomponents indicating operational;
indicating the reliability state, in the link information for the caller component, as marginal in response to the reliability states of the subcomponents indicating operational and non-operational; and
indicating the reliability state, in the link information for the caller component, as non-operational in response to the reliability states for the subcomponents indicating non-operational.

16. A method for determining a state of interrelated components in a system, comprising:
generating link information indicating a caller component, at least one callee component, a reliability pattern, in which the caller component and the at least one callee component participate, indicating a dependence between the caller component and the at least one callee component, and at least one link state indicating an operational state between the at least one callee component and the caller component;
determining a reliability state for the caller component based on the at least one link state of the at least one callee component and the reliability pattern; and
indicating the reliability state for the caller component.

17. The method of claim 16, wherein an aggregate reliability state of the system having multiple reliability patterns of components comprises:
operational if all the components in all the reliability patterns are operating;
non-operational if one or more reliability patterns failed or a component not in a reliability relationship with other components failed; and
marginal if one or more reliability patterns are in effect.

18. The method of claim 16, wherein there are a plurality of reliability patterns for components including an upstream reliability pattern whose components have dependency on components of a downstream reliability pattern, wherein a reliability state of the upstream reliability pattern is dependent on a reliability state of the downstream reliability pattern.

19. The method of claim 16, further comprising:
generating node information indicating reliability states of the caller and the callee components, wherein the reliability state of the caller component is based on link states between the caller component and the at least one callee component;
indicating the reliability state in the node information for the caller component as operational in response to the link states for the callee components indicating operational;
indicating the reliability state in the node information for the caller component as marginal in response to the link states for the callee components indicating both operational and non-operational; and
indicating the reliability state in the node information for the caller component as non-operational in response to the link states for the callee components indicating non-operational.

20. The method of claim 16, wherein the at least one callee component comprises subcomponents called by the caller component, wherein the link information is for the reliability pattern comprises redundancy where the caller component calls the subcomponents, wherein the subcomponents comprise a same type of component to provide redundancy reliability to the caller component, further comprising:
indicating a reliability state, in the link information for the caller component as caller, as operational in response to reliability states of the subcomponents indicating operational;
indicating the reliability state, in the link information for the caller component, as marginal in response to the reliability states of the subcomponents indicating operational and non-operational; and
indicating the reliability state, in the link information for the caller component, as non-operational in response to the reliability states for the subcomponents indicating non-operational.
